(19) United States
(12) Patent Application Publication
(10) Pub. No.: US 2008/0314223 A1
(43) Pub. Date: Dec. 25, 2008

(54) Saw Blade for Cutting Slots

(76) Inventor: Cornell Drajan, Hendersonville, NC (US)

Correspondence Address: SHOEMAKER AND MATTARE, LTD, 10 POST OFFICE ROAD - SUITE 110, SILVER SPRING, MD, 20910, US

(21) Appl. No.: 11/954,515

(22) Filed: Dec. 12, 2007

Related U.S. Application Data
(60) Provisional application No. 60/871,316, filed on Dec. 21, 2006.

(51) Int. Cl. B23D 57/00

(52) U.S. Cl. 83/835

(57) ABSTRACT

A saw blade for cutting a slot in a workpiece has two toothed sections, one at either end of the blade. The two sections lie in different—preferably perpendicular—planes. A slot is formed in a workpiece by first cutting one side of the slot with the toothed section at the front of the blade, and then cutting the bottom of the slot with the toothed section at the rear of the blade. A untoothed section between the two sets enables one to transition between the cutting directions, without having to turn the saw.

This application claims benefit of provisional patent application Ser. No. 60/871,316, filed Dec. 21, 2006.

### BACKGROUND OF THE INVENTION

This invention relates to a saw blade for cutting slots.

Conventional hand saws cut in a single direction. Some saws—those with broad blades, such as carpenters' saws and backsaws, are designed to produce a planar cut surface, while others like jig saws, are designed with narrow blades so that they can be turned while cutting. Narrow-bladed saws are more apt to wander from the desired blade position, and even they have minimum turn radii, so they are not suitable for cutting slots having sharp bottom corners. A few prior blades are made with spiral teeth or have abrasive surfaces so that they can cut in all directions, but it is difficult to control the cutting path with that type of blade.

### SUMMARY OF THE INVENTION

An object of the invention is to enable one to cut two sides of a slot in a piece of wood or other material without changing the orientation of a saw.

These and other objects are attained by a saw blade for cutting slots as described below.

### BRIEF DESCRIPTION OF THE DRAWINGS

In the accompanying drawings,

FIG. 1 is an isometric view of a saw having a blade embodying the invention;

FIG. 2 is an isometric view of a second embodiment of the invention; and

FIG. 3 is an isometric view of a third embodiment of the invention.

### DESCRIPTION OF THE PREFERRED EMBODIMENT

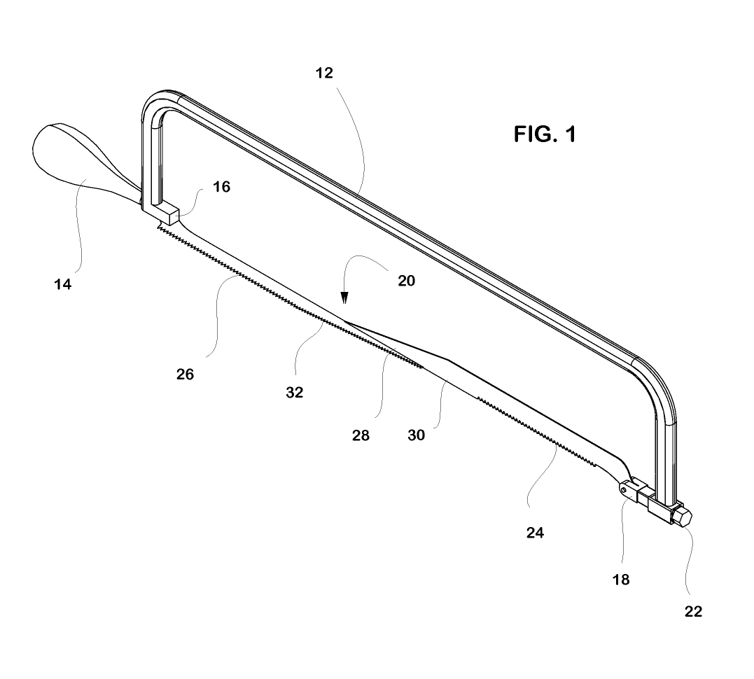

The hacksaw shown in FIG. 1 has a U-shaped frame 12 with a handle 14 at one end. Anchors 16, 18 at opposite ends of the saw support opposite ends of a flexible saw blade 20. The blade is maintained under tension by frame flexure, which can be altered by a threaded adjuster 22 (conventional, thus not shown in detail) at one end of the blade.

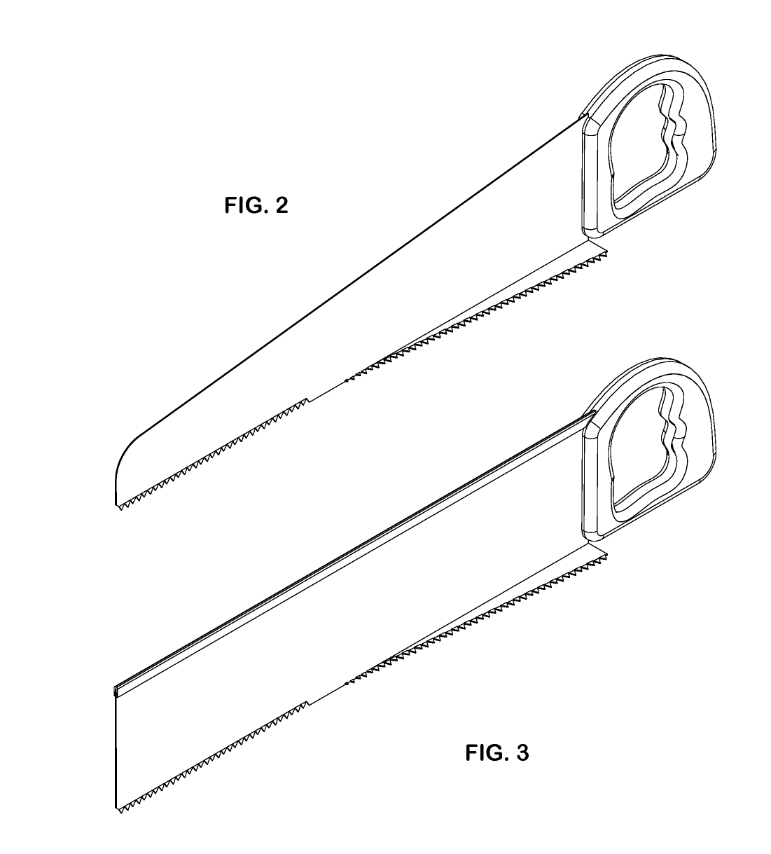

The novel features of the invention are in the blade itself. Unlike a conventional blade, all of whose teeth point generally in the same cutting direction, the blade illustrated has two sections whose teeth are directed in two different directions. Those in the forward section 24 of the blade are directed downward, that is, within the plane defined by the frame and the blade, whereas those in the rearward section 26 of the blade are directed to one side. The illustrated blade is considered right handed, with the rearward teeth directed to the user's right; it is also possible to make a left-handed version (e.g., FIG. 2) that would complement the version shown. Having complementary saws would enable the user to cut both sides of a slot without having to reverse the workpiece.

The front portion 24 of the blade is used to cut a first side of a slot in the workpiece, starting from one edge. Care is taken during this phase to use a short stroke, so that only the forward section of the blade engages the material. Once the desired bottom of the slot is reached, the blade is advanced so that the transition section 28 engages the workpieces. The forward portion 30 of the transition section has no teeth, to keep the user from overshooting the intended bottom of the slot. The sideways-facing teeth on the tapered portion 32 of the blade now begin to cut the slot bottom. After a few strokes, the slot bottom cut is wide enough that the rear section of the blade 26 can be used to saw the slot bottom to any desired width.

It is expected that the most common form of this invention will have the front and rear blade sections aligned in perpendicular cutting planes, i.e., at 90° to one another, blades could be made having other geometries, such as 45°, 60°, 120°, 135° or indeed any angle as desired, for example for cutting dovetail tenons.

The geometry and pitch of the teeth themselves may be designed to suit the material of the intended workpiece. For wood, the teeth in the forward section could be ripping teeth, while those in the rear section might be crosscut teeth, or vice-versa. This would be useful in situations where one side of the slot is parallel to the grain direction. For other orientations, both sets of teeth could be crosscut.

The best lead-in angle of the tapered portion may depend on tooth geometry and workpiece material. The presently preferred angle is about 5°. A lower angle would require a longer transition section, but would make the transition step smoother.

FIGS. 2 and 3 show other types of saws embodying the principles of the invention. The use of and design considerations for these saws are just as described above for the hacksaw version, except that the width of the slot which can be cut may be limited. The broader blades of FIGS. 2 and 3 may produce more precise surfaces on the side of the slot, and the width limitation could actually be useful as a gauge for cutting fixed-width slots. Of course, one could use a guide such as a miter box, particularly with the backsaw shown in FIG. 3.

Since the invention is subject to modifications and variations, it is intended that the foregoing description and the accompanying drawings shall be understand only to illustrate presently preferred examples.

I claim:

1. A saw blade for cutting slots in a workpiece, said blade comprising
a first toothed blade section lying in a first plane, for cutting the workpiece in a first direction to form one side of the slot, and a second toothed blade section lying in a second plane, for cutting the workpiece in a second direction at an angle to the first direction to form a bottom of the slot,
said first and second planes intersecting one another at an angle.

2. The invention of claim 1, wherein said planes are perpendicular to one another so that said first and second directions will be perpendicular.

3. The invention of claim 1, wherein said planes are non-perpendicular to one another.

4. The invention of claim 1, further comprising an untoothed transition section between said first and second sections.

5. The invention of claim 1, wherein one of said blade sections has ripping teeth and the other blade section has crosscut teeth.
